(19) United States
(12) Patent Application Publication
(10) Pub. No.: US 2009/0049493 A1
(43) Pub. Date: Feb. 19, 2009

(54) SYSTEM FOR DELIVERING MEDIA CONTENT

(75) Inventors: SCOTT WHITE, AUSTIN, TX (US); JAMES L. CANSLER, PFLUGERVILLE, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/840,463

(22) Filed: Aug. 17, 2007

(51) Int. Cl. H04N 7/173

(52) U.S. Cl. 725/110

(57) ABSTRACT

A system that incorporates teachings of the present disclosure may include, for example, a slave Set-Top Box (STB) receiver having a controller adapted to transmit a request for presentation to a master STB receiver to present one or more media content items stored in the master media STB receiver, select one among the one or more media content items presented by the master STB receiver, transmit to the master STB receiver a request for transmission of a select one of the one or more media content items, and receive from the master STB receiver the requested media content item in a progressive download format so that a portion of the requested media content item can be presented by the slave STB receiver while the remainder of the requested media content item is transmitted. Other embodiments are disclosed.

### FIELD OF THE DISCLOSURE

The present disclosure relates generally to media content and more specifically to a system for delivering media content.

### BACKGROUND

Media content processors such as Set-Top Box (STB) receivers can be expensive to manufacture in part because of costly resources such as large amounts of non-volatile memory, sophisticated digital high definition TV tuners, and so on. Consequently subscribers tend not to order more than one or two STB receivers for their residence or business establishment. With a limited number of STB receivers, subscribers are limited to where they can access the services of said receivers. For some subscribers it may be desirable to be able to access more STB receivers and corresponding media presentation devices (e.g., radio, TV, computer, etc.).

### BRIEF DESCRIPTION OF THE DRAWINGS

FIG. 1 depicts an exemplary embodiment of a communication system;

FIG. 2 depicts an exemplary embodiment of a portal of the communication system;

FIG. 3 depicts an exemplary method operating in portions of the communication system;

FIG. 4 depicts an exemplary embodiment of a functional configuration of media content processors in a building;

FIG. 5 depicts an exemplary graphical user interface (GUI) window presented during a transfer of media content between media content processors of the communication system; and

FIG. 6 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium operating in a first media content processor can have computer instructions for receiving a request for presentation from a second media content processor to present one or more media content items stored in the first media content processor, presenting at least a portion of the requested one or more media content items at the second media content processor, receiving a request for transmission of a select one of the one or more media content items, and transmitting to the second media content processor the requested media content item in a progressive download format so that a portion of the requested media content item can be presented by the second media content processor while the remainder of the requested media content item is transmitted.

In one embodiment of the present disclosure, a slave Set-Top Box (STB) receiver can have a controller adapted to transmit a request for presentation to a master STB receiver to present one or more media content items stored in the master media STB receiver, select one among the one or more media content items presented by the master STB receiver, transmit to the master STB receiver a request for transmission of a select one of the one or more media content items, and receive from the master STB receiver the requested media content item in a progressive download format so that a portion of the requested media content item can be presented by the slave STB receiver while the remainder of the requested media content item is transmitted.

In one embodiment of the present disclosure, a method can involve exchanging media content between Set-Top Box (STB) receivers in a progressive download format in which a portion of the media content being exchanged can be presented by a recipient STB receiver while the remainder of the media content is transmitted by a submitting STB receiver.

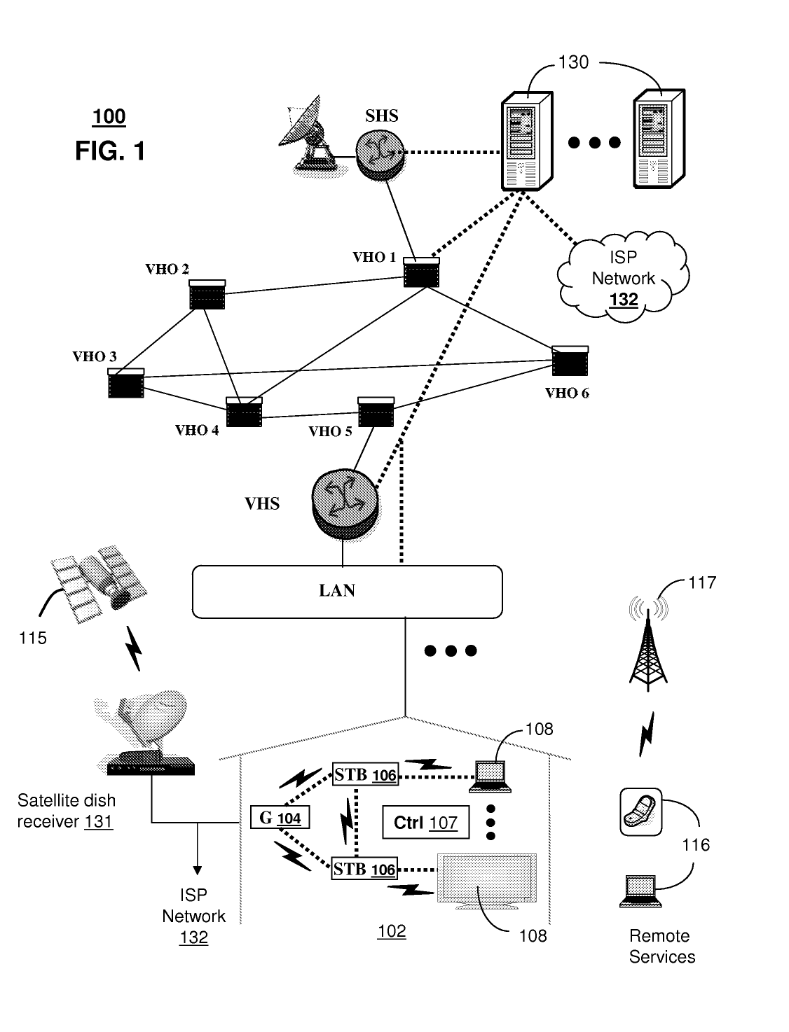

FIG. 1 depicts an exemplary embodiment of a communication system 100. The communication system 100 can represent an IPTV broadcast media system. In a typical IPTV infrastructure, there is at least one super head office server (SHS) which receives national media programs from satellite and/or media servers from service providers of multimedia broadcast channels. In the present context, media programs can represent audio only content, video only content, and/or combinations thereof. The SHS server forwards IP packets associated with the media content to video head servers (VHS) via a network of video head offices (VHO) according to a common multicast communication method.

The VHS then distributes multimedia broadcast programs to commercial and/or residential buildings 102 housing a gateway 104 (e.g., a residential gateway or RG). The gateway 104 distributes broadcast signals to media content processors 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media content processors 106 and subsystems of the IPTV media system for services such as video-on-demand (VoD).

The IPTV media system can be coupled to one or more computing devices 130 that can operate as a web or Internet server for providing portal services over an Internet Service Provider (ISP) network 132 to fixed media devices 108 or portable communication devices 116 by way of a wireless base station 117 such as in a cellular communication network operating with common protocols (GSM, CDMA, etc.).

A satellite broadcast system can be used in place of the IPTV media system. In this embodiment, signals transmitted by a satellite 115 can be intercepted by a satellite dish receiver 131 coupled to building 102 which conveys media signals to the media content processors 106 by way of gateway 104. The media content processors 106 can be equipped with a broadband port to the ISP network 132. Although not shown, the communication system 100 can also be combined or replaced with analog or digital broadcast distributions systems such as cable systems. It would be apparent therefore to one of ordinary skill in the art that the present disclosure can be applied to any media content system.

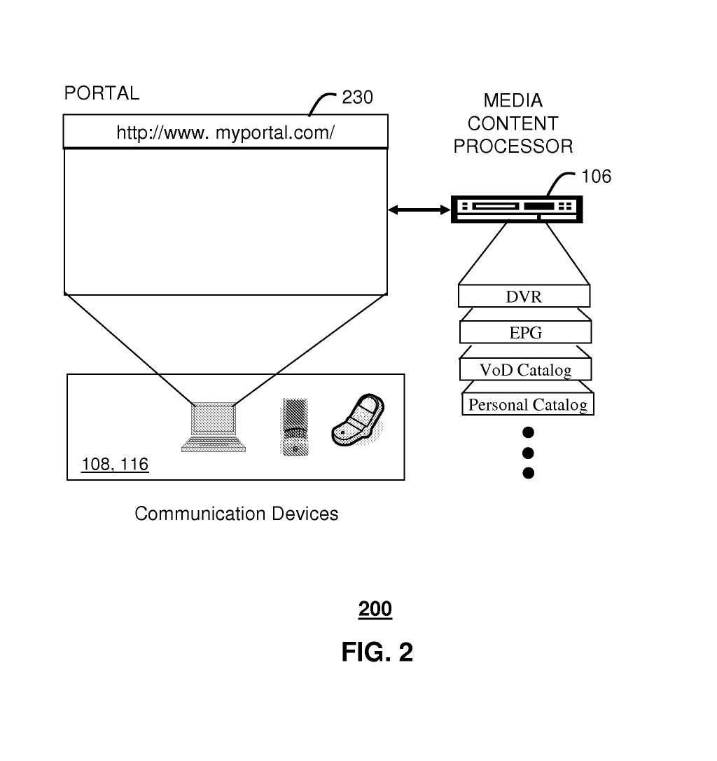

FIG. 2 depicts an exemplary embodiment of a portal 230 of the communication system 100. In FIG. 2, the portal 230 can be accessed by a URL with a common browser such as Microsoft's Internet Explorer using an Internet-capable fixed or portable communication device 108, 116. The portal 230 can be configured to access a media content processor 106 such as the STB of FIG. 1 and services managed thereby such as a Digital Video Recorder (DVR), an Electronic Programming Guide (EPG), Video on Demand (VoD) catalog, a personal catalog stored in the STB (e.g., personal videos, pictures, audio recordings, etc.), and so on by way of the gateway 104.

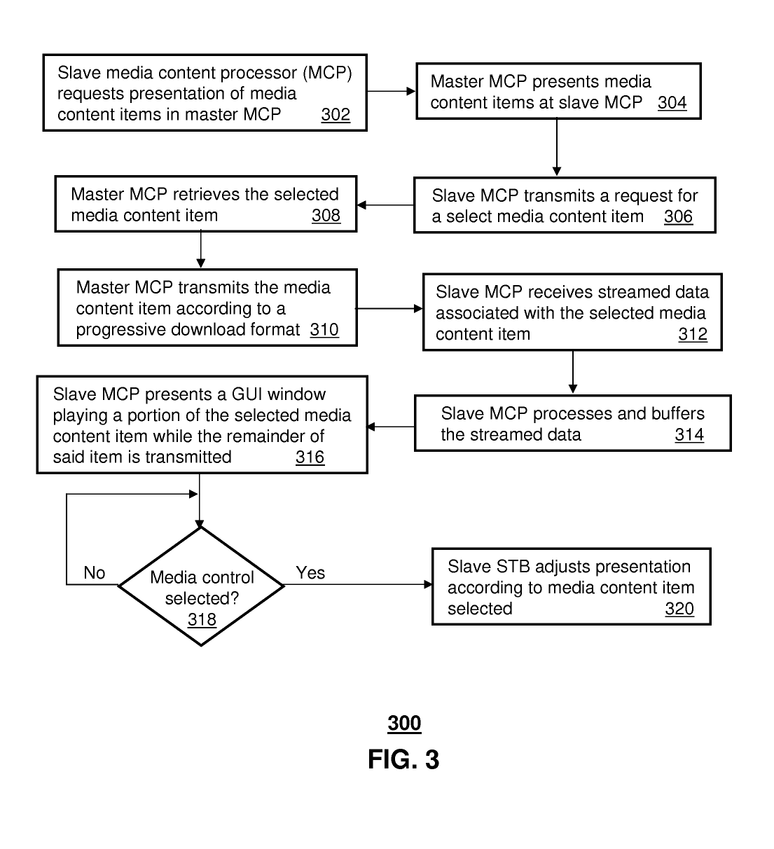

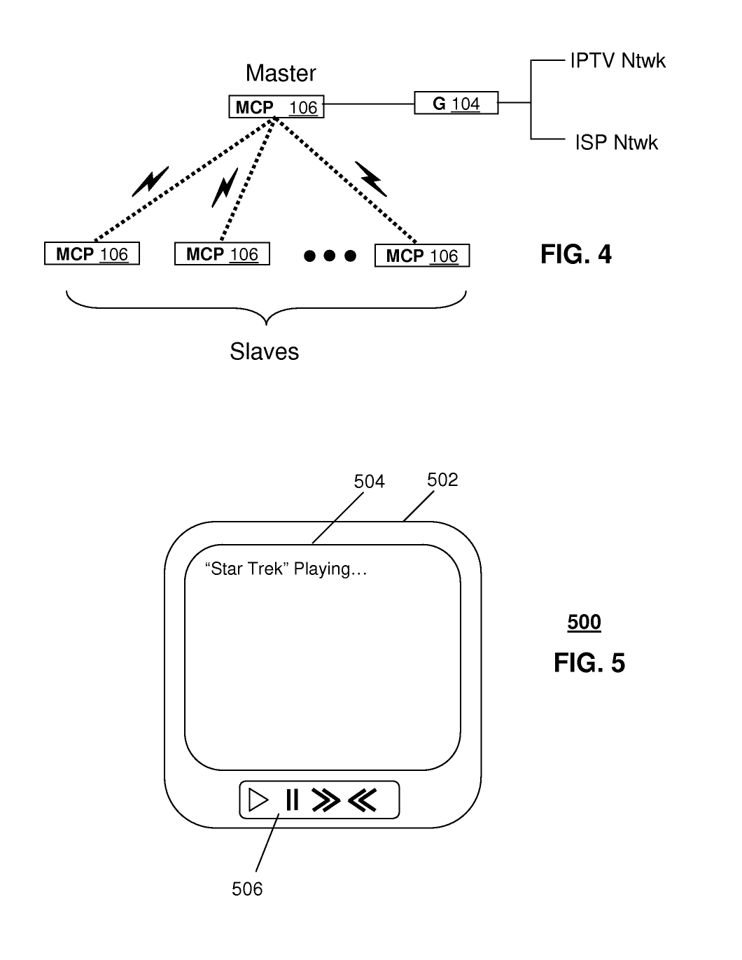

FIG. 3 depicts an exemplary method 300 operating in portions of the communication system 100. FIG. 4 depicts a master-slave media content processor (herein referred to as MCP) architecture which can be applied to method 300. A master MCP 106 in the present context can refer to an STB receiver with greater computing resources (e.g., more memory, more tuners for receiving and recording programs, etc.) than the computing resources of a slave MCP 106. Consequently, a master MCP 106 can be utilized for downloading and storing more media content than a slave MCP 106. Such an architecture can prove useful to encourage subscribers to purchase or rent more MCPs 106 since collectively master and slave MCPs are less expensive than having a number of MCPs with the resources of a master MCP.

With this in mind, method 300 begins with step 302 in which a slave MCP 106 transmits a request for presentation of the media content items stored in a master MCP 106. The master MCP 106 can present in step 304 by common means the media content items at the slave MCP 106 over a wired or wireless communication medium as shown in FIG. 4. The wireless communication medium can for example comply with a Wireless Fidelity (WiFi) standard. Other wireless communication mediums can be utilized such as Bluetooth, Ultra Wideband (UWB), or any other suitable short range communication method. The wired communication medium can be compliant with Ethernet communications, communication over power lines, or any other suitable wired communication means.

The slave MCP 106 can in step 306 transmit a request for a select media content item stored in the master MCP. The transmission can be responsive to a selection made by the subscriber using the slave MCP 106 while viewing and selecting by way of a media controller 107 and a media device 108 coupled to the slave MCP the media content items stored in the master MCP. Responsive to this request, the master MCP 106 can retrieve and process the selected media content item in step 308 to transmit it to the slave MCP in step 310 according to a progressive download format. A progressive download format can be a form of streamed packets transmitted to a recipient MCP which allows it to buffer the streamed information and begin its presentation while transmission is on-going.

Accordingly, in step 312 the slave MCP 106 receives the streamed data, processes and buffers it in its memory in step 314. In step 316 it begins presentation of a graphical user interface (GUI) window 502 as shown in FIG. 5 playing an initial portion of the selected media content item while the remainder of said media content item is transmitted by the master MCP. The GUI window 502 can have a viewing area 504 with media controls 506 below (e.g., play, pause, fast-forward, and fast-rewind). Using common trick playback techniques, any one of the media controls 506 can be selected to affect presentation of the progressively downloaded media content. Thus when a selection of a media control 506 is detected in step 318, the slave MCP 106 can be programmed to adjust the presentation of the progressively downloaded media content (e.g., pause, rewind, etc.).

Upon reviewing the aforementioned embodiments, it would be evident to an artisan with ordinary skill in the art that said embodiments can be modified, reduced, or enhanced without departing from the scope and spirit of the claims described below. Method 300 can be applied in a system where the MCPs 106 have equal computing resources, and not one MCP is necessary a master over another. In this embodiment, the MCPs 106 can be programmed to transfer media content between them utilizing a progressive download format. Additionally, MCPs 106 can represent other media content processing devices such as a laptop computer, a desktop computer, or any other suitable computing device capable of exchanging, processing, and presenting media content.

In yet another embodiment, a subscriber of a slave STB receiver 106 can perform the steps of method 300 remotely by way of portal 230. In this embodiment, the portal 230 can be utilized to establish communication with the slave MCP 106 by way of gateway 104. Once communications are established, the subscriber can remotely control the slave MCP 106 as if situated in building 102 and thereby perform the steps of method 300.

These are but a few examples of modifications that can be applied to the present disclosure without departing from the scope of the claims. Accordingly, the reader is directed to the claims section for a fuller understanding of the breadth and scope of the present disclosure.

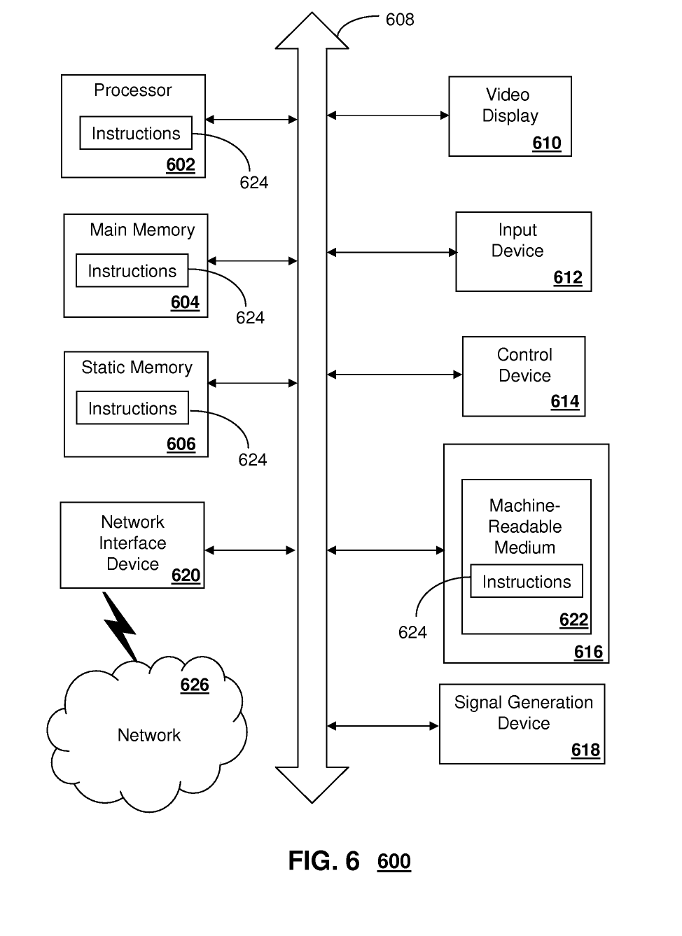

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium operating in a first media content processor, comprising computer instructions for:
receiving a request for presentation from a second media content processor to present one or more media content items stored in the first media content processor;
presenting at least a portion of the requested one or more media content items at the second media content processor;
receiving a request for transmission of a select one of the one or more media content items; and
transmitting to the second media content processor the requested media content item in a progressive download format so that a portion of the requested media content item can be presented by the second media content processor while the remainder of the requested media content item is transmitted.

2. The storage medium of claim 1, wherein each of the one or more media content items corresponds to one among audio content, and video content.

3. The storage medium of claim 1, wherein each of the one or more media content items corresponds to one among media content downloaded from a Video on Demand (VoD) catalog, media content recorded by a Digital Video Recorder (DVR) managed by the first media content processor, and media content downloaded from a media content source by way of an Internet Service Provider (ISP) network coupled to the first media content processor.

4. The storage medium of claim 1, wherein the requested media content is transmitted over one among a wireless Local Area Network (LAN), and a wireline LAN.

5. The storage medium of claim 4, wherein the wireless LAN conforms to a Wireless Fidelity (WiFi) protocol.

6. The storage medium of claim 1, wherein the second media content processor presents a Graphical User Interface (GUI) window with at least one or more controls for managing presentation of the requested media content item.

7. The storage medium of claim 1, wherein each of the first and second media content processors corresponds to a Set-Top Box (STB) receiver, and wherein the STB receiver operates in one among an Internet Protocol Television (IPTV) communication system, a satellite TV communication system, and a cable TV communication system.

8. The storage medium of claim 1, comprising computer instructions for streaming the requested media content item to the second media content processor according to the progressive download format.

9. A slave Set-Top Box (STB) receiver, comprising a controller adapted to:
transmit a request for presentation to a master STB receiver to present one or more media content items stored in the master media STB receiver;
select one among the one or more media content items presented by the master STB receiver;
transmit to the master STB receiver a request for transmission of a select one of the one or more media content items; and
receive from the master STB receiver the requested media content item in a progressive download format so that a portion of the requested media content item can be presented by the slave STB receiver while the remainder of the requested media content item is transmitted.

10. The slave STB receiver of claim 9, wherein each of the one or more media content items corresponds to one among audio content, and video content, and wherein each of the STB receivers operate in one among an Internet Protocol Television (IPTV) communication system, a satellite TV communication system, and a cable TV communication system.

11. The slave STB receiver of claim 9, wherein each of the one or more media content items corresponds to one among media content downloaded by the master STB receiver from a Video on Demand (VoD) catalog, media content recorded by a Digital Video Recorder (DVR) managed by the master STB receiver, and media content downloaded to the master STB receiver from a media content source by way of an Internet Service Provider (ISP) network coupled to the master STB receiver.

12. The slave STB receiver of claim 9, wherein the controller is adapted to receive the requested media content from the master STB receiver over one among a wireless Local Area Network (LAN), and a wireline LAN.

13. The slave STB receiver of claim 9, wherein the controller is adapted to:
process streamed data associated with the requested media content item according to the progressive download format; and
present a Graphical User Interface (GUI) window with at least one or more controls for managing presentation of the requested media content item.

14. A method, comprising exchanging media content between Set-Top Box (STB) receivers in a progressive download format in which a portion of the media content being exchanged can be presented by a recipient STB receiver while the remainder of the media content is transmitted by a submitting STB receiver.

15. The method of claim 14, wherein the media content exchanged between the STB receivers corresponds to one among audio content, and video content, and wherein each of the STB receivers operate in one among an Internet Protocol Television (IPTV) communication system, a satellite TV communication system, and a cable TV communication system.

16. The method of claim 14, wherein the STB receivers operate in a master-slave arrangement.

17. The method of claim 16, wherein a master STB receiver comprises more computing resources than a slave STB receiver.

18. The method of claim 14, wherein each of the media content corresponds to one among audio content, and video content

19. The method of claim 14, wherein each of the STB receivers operate in one among an Internet Protocol Television (IPTV) communication system, a satellite TV communication system, and a cable TV communication system.

20. The method of claim 14, wherein the media content corresponds to one among media content previously downloaded by one of the STB receivers from a Video on Demand (VoD) catalog, media content recorded by a Digital Video Recorder (DVR) managed by the STB receiver, and media content previously downloaded from a media content source by way of an Internet Service Provider (ISP) network coupled to the STB receiver.
